(19) United States
(12) Patent Application Publication
(10) Pub. No.: US 2005/0074204 A1
(43) Pub. Date: Apr. 7, 2005

(54) Spectral plane method and apparatus for wavelength-selective optical switching

(76) Inventors: Gordon Wilson, San Francisco, CA (US); Joseph E. Ford, Del Mar, CA (US)

Correspondence Address: Jeffery J. Brosemer, Ph.D., ESQ., 138 S. Telegraph Hill Road, Holmdel, NJ, 07733, US

(21) Appl. No.: 10/677,978

(22) Filed: Oct. 2, 2003

(51) Int. Cl. G02B 6/28

(52) U.S. Cl. 385/24

(57) ABSTRACT

We describe a variable bandwidth tunable optical spectral filtering device and associated method for selectively directing a portion of a wavelength multiplexed input signal, entering through one or more optical fibers, into one or more output signals provided to one or more optical fibers and/or electronic outputs. The optical filtering is accomplished using free-space diffractive wavelength de-multiplexing optics combined with a fixed (permanent) patterned structure located in the spectrally dispersed image plane. The structure can direct a selected spectral portion of the optical signal to one or more separate outputs, such as an optical fiber or power detector. A single active element in the optical path is used to spatially shift, or steer, the entire input spectrum at the dispersed spectral image plane, to control the portion of the input spectrum illuminating specific features on the permanent patterned structure. In one preferred embodiment, a device with a fixed selective area triangular shaped tilted reflective facet on a flat reflective surface is constructed such that the light reflected off the flat reflective surface and off the triangular reflective facet are selectively multiplexed back and directed to different output fiber ports. Inputs at different angles of incidence on the reflective structures may be deflected by the same structures to different output port fiber ports. A reconfigurable variable-bandwidth tunable optical add/drop multiplexing device is constructed using such a filtering device and an application of such an add/drop multiplexing in a optical transport network is demonstrated.

### FIELD OF THE INVENTION

This invention relates generally to the field of optical communications and in particular to a variable bandwidth tunable optical filtering device for selectively dropping or adding optical signal channels as a function of wavelength out of multi-channel optical signal transmitted through a multi-node optical communication network.

### BACKGROUND OF THE INVENTION

In a Wavelength Division Multiplexed (WDM) optical communication network, a multiplexed optical signal at different wavelengths is transmitted between different network nodes of the network. Optical add/drop multiplexing (OADM) in a network allows connections to be made selectively between any two, but not necessarily restricted to two, different network nodes without disturbing the communication anywhere in the rest of the network.

In a simple OADM called a fixed OADM (FOADM), a fixed band-pass filter is used to selectively drop channels at a “drop” port or add optical signal channels at an “add” port (drop or add channels, respectively) at some pre-designated wavelength(s) at a network node. The remaining channels (express or through channels) are transmitted through an “express” (or through) port at the network node without any significant signal impairment. Wavelength selection at different network nodes is achieved by using different fixed band-pass filters. Unfortunately however, this method offers limited flexibility in choice of wavelength(s) to be dropped or added and is not dynamically re-configurable.

For a more flexible and efficient network operation, dynamic and/or remote re-configurability of optical signal channels at any given network node is desirable. Re-configurable OADM (ROADM) dynamically and/or remotely selects wavelength signal channels to be dropped/added at different wavelengths. Advantageously, selection is done depending upon the network requirements and network dynamic conditions.

In practice, all signal channels of a multiplexed optical signal are de-multiplexed at each network port to drop the desired optical signal channel(s) at that node or to add new optical signal channel(s). Typically, an ROADM comprises a de-multiplexer to separate the input wavelength signals into distinct paths; an array of 2-by-2 switches, one in each de-multiplexed path, to either pass or add and drop the signals at each of the wavelengths, and a multiplexer to combine the expresses and added channels and pass them to the designated output for further transmission. To effect this operation, a combination of wavelength de-multiplexing/multiplexing devices such as Arrayed Waveguide Grating (AWG) filters and switches at each network node are oftentimes employed.

Although such a device allows for any combination of channels to be added and dropped, it requires a large number of constituent parts and is therefore expensive. Moreover, the insertion loss and polarization-dependent loss of the system is typically high due to the large number of components that must be passed through from input to output.

Consequently, there exists a continuing need for improved apparatus and methods that provides for re-configurable optical add/drop multiplexing with reduced complexity and cost.

### SUMMARY OF THE INVENTION

The present invention describes a novel multi-input/output variable bandwidth tunable optical filtering device and a method to operate the same as a ROADM in optical transport networks. In contrast with the prior art techniques, the single device offers remote and/or dynamically tunable ROADM operation with a high degree of flexibility.

The optical filtering device uses free-space diffractive wavelength demultiplexing and remultiplexing optics and an optical spectral plane filter with permanent physical patterns on a substrate.

The physical patterns on the spectral plane filter are designed to reflect, transmit or diffract the light either at the same angle, complementary angle, or some other angle depending on the lateral position of the incident light. Each different reflected/diffracted/transmitted angle corresponds to a different output port of the filtering device. Thus the spectral plane filter selectively directs different wavelength optical signal channels from one or more input ports to one or more output ports.

The spectral plane filter placed at the spectrally dispersed image plane of a multi-wavelength input optical signal selectively directs or switches one or more optical signal channels from a group of spectrally dispersed and spatially separated optical signal channels to different output ports. Using a single actuator with two degrees of freedom, both the center frequency of each filter in a predefined set of filter shapes and the filter selected can be changed. Furthermore, certain types of filter switching operations may be performed without interrupting the optical signal channels that are not being switched.

For example, one may construct a multi-port ROADM filter that drops and/or adds a band of optical signal channels such that the center wavelength of the drop band can be changed without interrupting optical signal channels that remain in the express path (not dropped and/or added). The bandwidth of the filter may also be changed without interrupting add/drop and express channels that are not switched. The signals at different ports can then be processed locally or transmitted further as the requirement may be. By similar principles, signal(s) at different wavelength(s) from more than one input port can be combined into a common output port.

In operation, the multi-wavelength multiplexed input optical signal is first de-multiplexed by a dispersive element such as a diffraction grating. The portion of the multi-wavelength input optical signal that illuminates a physical pattern on the permanent spectral plane filter at the spectrally dispersed image plane is controlled by changing the relative position of the dispersed input spectrum and the spectral plane filter by laterally shifting the position of either the spectrum, the spectral plane filter, or some combination of the two.

### BRIEF DESCRIPTION OF THE DRAWINGS

FIG. 1 is illustration of the principle of a variable bandwidth tunable optical filtering device for ROADM application in accordance with the invention;

FIG. 2 shows the effect of grating tilt on the spectrally dispersed image;

FIG. 3a to 3d shows different options for steering a spectrally dispersed beam;

FIG. 4 shows a schematic of a spectral plane filter to illustrate the principle of directing different wavelengths to drop and express output ports, respectively;

FIG. 5a to 5f shows types of patterned permanent spectral plane structures;

FIG. 6 shows a specific example of static spectral plane with a triangular diffraction grating to illustrate the principle of signal drop operation;

FIG. 7 shows a schematic of a triangular grating to illustrate the principle tuning the center wavelength and/or bandwidth of optical drop channels;

FIG. 8 shows variable bandwidth ROADM drop spectrum;

FIG. 9a shows an example of a device having two inputs and two outputs according to the teachings of the present invention and FIG. 9b shows the inputs and corresponding outputs for the device depicted in 9a;

FIG. 10 shows a double-pass configuration to implement ROADM function using a variable bandwidth tunable spectral filtering device device;

FIG. 11 shows configurations of guiding the optical output power to a fiber;

FIGS. 12a and 12b show examples of angle/displacement conversion optics using a prism and gratings respectively, together with a spectral plane filter such that the output beams leave the spectral plane filter parallel;

FIG. 13 shows an example of a double-pass configuration to implement ROADM function using a variable bandwidth tunable spectral filtering device with a prism for angle/displacement conversion;

FIG. 14 shows an example of using ROADM in conjunction with a periodic AWG;

FIG. 15 shows a spectrum steering ROADM system using lateral actuation of the patterned spectral plane filter;

FIG. 16 shows a schematic arrangement to generate electrical feedback control signal for the tip/tilt grating stage for beam steering;

FIG. 17 shows the principle of feedback control using a combination of patterned spectral plane filter and a photo-detector; and

FIG. 18 shows an example of a MEMS tilt grating for beam steering application.

### DETAILED DESCRIPTION OF THE INVENTION

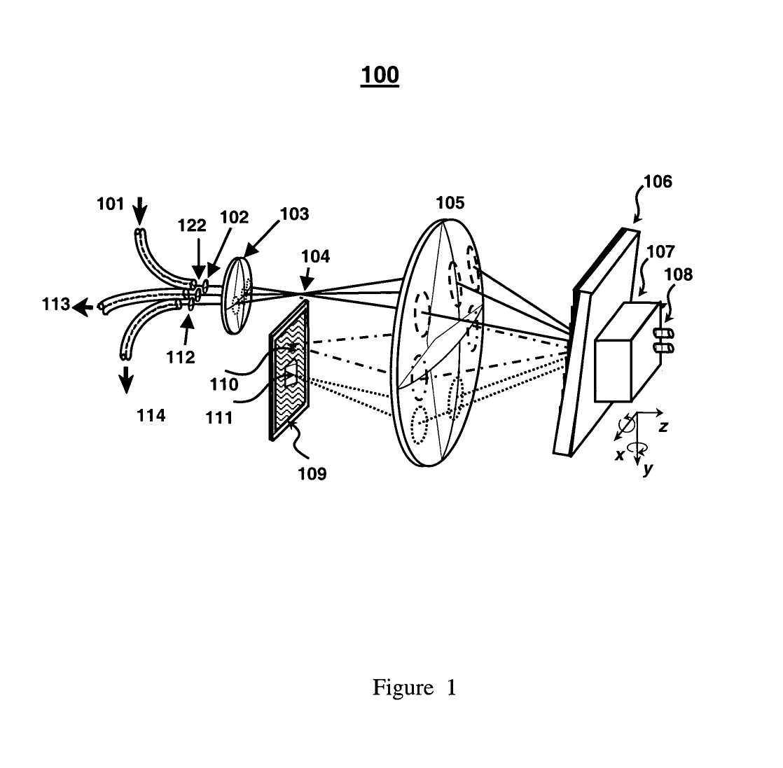

FIG. 1 illustrates the basic concept of the optical filtering device of the present invention. Three optical fibers 101, 113 and 114 connect to the optical system 100, however, the configuration shown here can be scaled to larger number of input and/or output fibers. Any of the three fibers can be used as an input or an output port of the device. For illustrative purposes 101 is depicted as the sole input fiber.

With continued reference now to FIG. 1, multi-wavelength optical input signal carried on optical fiber 101 exits the end facet and is collimated by a micro-optic lens 102. The collimated beam passes through a second micro-optic lens 103 slightly off-center from the optical axis so that the input signal is focused to a focal point 104 at an angle to the optical axis forming the source for the spectrally dispersive image system. The combination of the micro-lenses 102 and 103 may result in an anamorphic optical system producing either a symmetrical or asymmetrical beam with the ratio of the lengths of the major and minor axes of the elliptical beam cross section chosen to be some value between 1 to 10. The other micro-lenses 112 and 122 may be identical to 102 so that the same asymmetry is applied to any beam emitted from any of the fibers 101, 113 or 114.

The input light from the focal point 104 is collimated by a lens 105 and illuminates planar reflective diffraction grating 106 mounted on a tip/tilt stage 107 capable of controllably rotating the grating 106 about multiple axes as directed by electrical signals received via electrical connections 108. Each component of the multi-wavelength input signal is diffracted at a distinct angle by the grating 106 corresponding to its wavelength. The spectrally dispersed diffracted signals are focused by a second pass through lens 105 and are imaged in a line on a permanent static optical spectral plane filter 109.

For illustrative purposes the spectral plane filter 109 in this example is shown to have two distinct regions—a uniform reflective field region 110 normal to the optical axis and a flat wedge shaped reflective region 111, at a different angle. However, any other combination of reflective physical features on the spectral plane filter may be present. Generally speaking, each physical feature on the spectral plane filter directs those wavelength signals impinging on it at a particular angle to one of the several output ports. Moreover, the same spectral plane feature may direct light from one input fiber to one output fiber and from another input fiber to a different output fiber.

For example, in this case, the input signal channels striking the flat region 110 of the spectral plane filter 109 are reflected at a complementary angle back through the system and pass through point 104. They are collimated by lens 103 and focused into the output fiber 114 by a micro-lens 112. The wavelength signals striking the angled facet 111 are reflected at a different angle parallel to the optical axis. They pass through the point 104 and are collimated by lens 103 and focused by lens 122 into output fiber 113. When used as a tunable drop filter, outputs 114 and 113 could be the express and the drop ports, respectively.

The arrangement in FIG. 1 is shown for illustrative purposes. The lateral position of the input and output fibers, and their corresponding micro-collimating lenses could be changed or interchanged in two dimensions across a plane normal to the optical axis, so long as the angles of reflection from spectral plane filter 109 are changed correspondingly. The relationship between the lateral positions of two fibers relative to the optical axis, and the angle of reflection required at the spectrally dispersed image plane needed to direct light from one fiber to the other is readily deducible from the basic principles of 4f imaging.

As can be appreciated, the optical filtering device may be designed for any number of drop ports, each corresponding to a different faceted region or regions on the spectral plane filter with a particular angle of reflection. Advantageously, multiple discontinuous facets may be included on the same spectral plane filter.

Continuing our discussion of FIG. 1, the multi-wavelength input optical signal is dispersed by grating 106 into a column of light spots on the spectral plane filter. The position of each spot is determined according to the wavelength of each component of the input signal. More specifically, the permanent spectral plane filter 109 has no controls to change the effect it has upon the multi-wavelength input optical signal. In the device shown in FIG. 1, the lateral position of the dispersed spectrum is controlled by tip/tilt stage 107 to rotate the grating 106 to the appropriate angle around its X-axis and Y-axis. Tilt of the collimated beam translates into lateral shift of the dispersed spectra on the spectral plane filter 109. As can now be appreciated by those skilled in the art, instead of changing the position of the spectral plane filter, the lateral position of the entire dispersed spectrum is adjusted as a result of electrical signals received via electrical connections 108 so as to align the desired input signal channels with specific features of the permanent spectral plane filter to selectively direct those input channels to a specific output port.

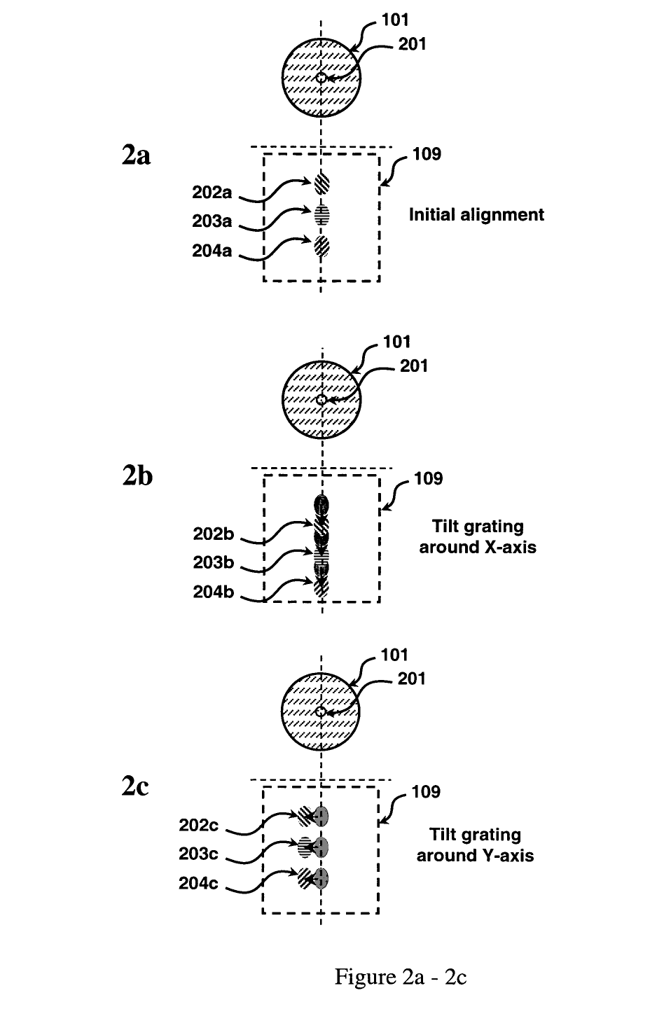

The operation of laterally shifting the spectrum is understood with reference to FIGS. 2a-2c, which show the direct image of the face of input fiber 101 such that the central single mode optical fiber core 201 is visible. The dispersed spectral plane 109 is positioned below the input fiber 101 by appropriate initial alignment of the optical system. Three wavelength signals 202, 203 and 204 (shown as 202a, 203a, and 204a; 202b, 203b, and 204d; and 202c, 203c and 204c in FIG. 2A, FIG. 2B and FIG. 2C, respectively. For the purposes of illustration, 203(a-c) are drawn corresponding to 1530 nm, 1540 nm, and 1550 nm wavelengths respectively. Additionally, while the dispersed spectral plane is shown positioned below the input/output fiber, it is not necessary that such positioning is required. More specifically, any relative orientation is contemplated and satisfactory for the purposes of the present invention.

With simultaneous reference now to FIGS. 1 and 2(a-c), the three wavelength signals are all emitted from the single mode fiber core 201, where they overlap. After making a first pass through the spectral de-multiplexing system 100 the three signals are imaged into a column of spots in the spectrally de-multiplexed plane 109, where the vertical position of each spot is approximately proportional to signal wavelength. In the initial alignment state of the system shown in FIG. 2a, the column of spots 202a, 203a and 204a is centered in the spectrally de-multiplexed plane 109. FIG. 2b shows the result when the reflective grating 106 is rotated about the X-axis. The spots have the same position relative to each other, but each spot is vertically shifted to new positions 202b, 203b and 204b. FIG. 2c shows the result when the reflective grating 106 is rotated about the Y-axis. The spots have the same position relative to each other, but each spot is laterally shifted to new positions 202c, 203c and 204c. This type of actuation may be described as “spectrum steering”, as the input spectrum is steered to the required position on the permanent spectral plane structure, as opposed to changing the spectral plane filter itself.

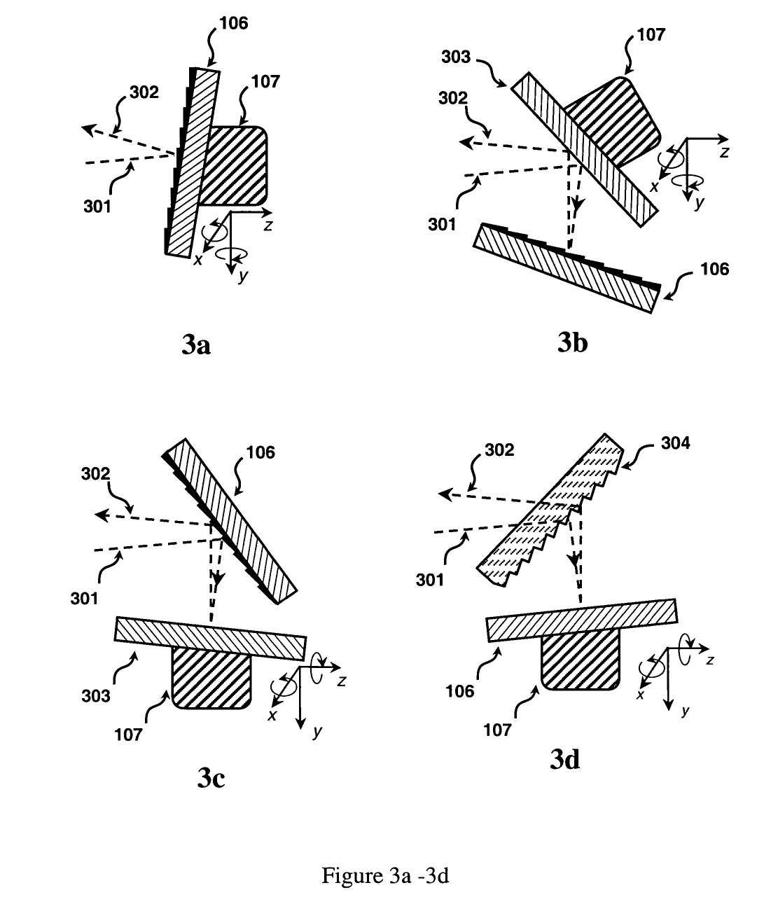

FIG. 3 shows several exemplary means for applying tilt to the reflected multi-wavelength signal. There exists a substantial body of engineering expertise in optical beam scanning systems, as described for example in the book “Optical Scanning”, authored by Gerald Marshall, Ed., and published by Marcel Dekkar, Inc. in 1991. It is understood that one skilled in the art would be able to draw upon the prior art of such systems to construct related means for accomplishing substantially identical functions.

With continued reference to FIG. 3 and in particular to FIG. 3a, there is shown an illustrative single wavelength input beam 301 incident on reflective diffraction grating 106 which is mounted directly on 2-axis tip/tilt mount 107 used to control the direction of the diffracted output signal 302.

In FIG. 3b input beam 301 is reflected from a first-surface mirror 303 mounted on tip/tilt stage 107 and to illuminate reflective diffraction grating 106, now stationary, such that the diffracted output signal 302 reflects again from mirror 303. As in FIG. 3a, the tip/tilt stage controls the direction of the diffracted output, but in this configuration the output angle is approximately twice as sensitive to tip/tilt stage angle as in FIG. 3a. In FIG. 3c, the input signal 301 is diffracted from stationary reflective diffraction grating 106 and illuminates first surface mirror 303 mounted on tip/tilt stage 107. Mirror 303 is oriented so that the reflected signal is incident on reflective diffraction grating 106 where it diffracts a second time. This configuration provides approximately twice the change in output angle as a function of input wavelength (spectral dispersion) as in configurations shown in FIGS. 3a and 3b.

In FIG. 3d, input signal 301 is diffracted in passing through transmissive diffraction grating 304 then is incident upon first surface mirror 303 mounted on tip/tilt stage 107. The reflected signal is diffracted again by a second pass through transmissive grating 304 to output 302. In configurations 3c and 3d, where the scanned surface is the second reflective surface, rotation of the tip/tilt stage about the z axis controls lateral position of the imaged dispersed signals 202, 203 and 204 drawn in FIG. 2.

In each of the systems shown in FIGS. 3(a-c), the active moving element can be actuated by any of the means known in the art of optical scanning including, for examples, stepper motor driven screws, piezoelectric direct or screw drive actuators, torsional galvanometric actuators, thermal expansion actuation, and direct manual actuators. Other means known in the art for optical beam steering include micro-electro-mechanical systems (MEMS) actuators such as the devices used for constructing large port-count optical cross-connects. Such cross-connects typically involve two dimension arrays of dozens or hundreds of 2-axis gimbal-mounted beam steering mirrors, where electro-magnetic or electrostatic actuators control each mirror. In the current invention only a single, relatively large diameter, tilt-mirror is required but the same fabrication and drive techniques are applicable.

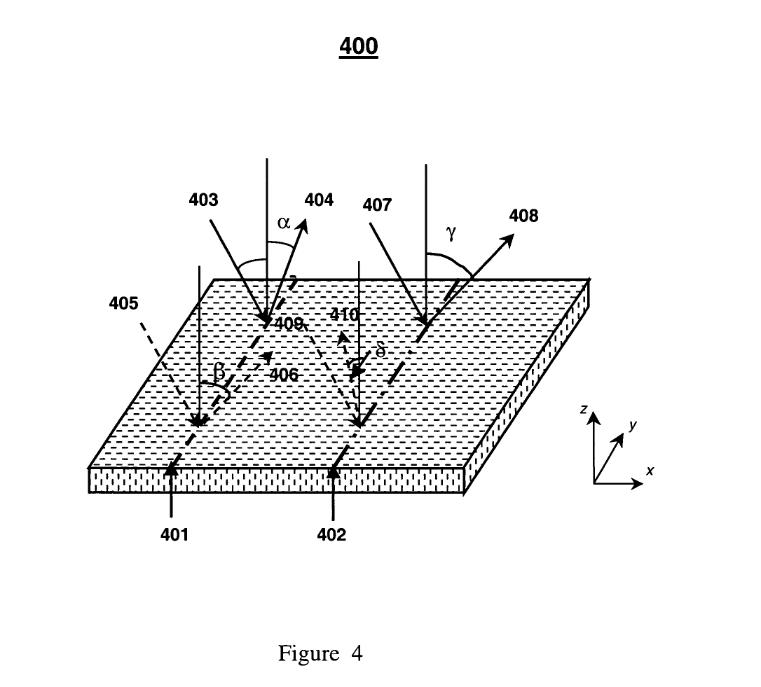

Principles of OADM application of the optical filtering device is described with reference to FIG. 4 showing a spectral plane filter 400 at the spectrally dispersed image plane. The multi-wavelength input signal is imaged as a column of light spots in the y-direction. The spectral plane filter may have different physical features that selectively reflect/diffract light at different angles. Each reflected/diffracted angle corresponds to a different output port. Variations in the physical features on the spectral plane filter along the y-direction result in different regions of the spectrum being reflected/diffracted at different angles. In general there may be multiple input fibers and signals from each input fiber will be incident on the spectral plane filter at different angles. For simplicity, one input fiber and one incident angle are assumed in the figure.

In this example shown in FIG. 4, light spots from the dispersed image fall along a column in y-direction shown by line 401 on the spectral plane filter 400. An input signal 403 at a given wavelength is reflected as 404 at an angle α, whereas another input signal 405 at a different wavelength is reflected as 406 at angle β. When the spectrum is translated in the x-direction to a new position shown by line 402, angles of reflection may be changed to γ and δ, respectively. Although the incident angle of the input signals at these positions shown by 407 and 409 respectively does not change the signal is reflected along 408 and 410, respectively. Thus, translating the spectrum in the x-direction switches input signals from one output to another on a wavelength-by wavelength basis.

Translating the spectrum in the y-direction changes the wavelength registration of the spectral plane filter. For example, if the spectrum is translated so that input signal 403 strikes the spectral plane filter at the same location previously hit by input signal 405, it will be directed to the same output 406, as input signal 405 originally was. Thus those skilled in the art can see that any wavelength can be directed to any of the output ports by translating the dispersed input beam in x- or in y-direction without moving the spectral plane filter.

Many different types of optical filters can be used to achieve the said functionality in a spectral plane filter. For example, a permanent spectral plane filter can be constructed using a variety of techniques developed in prior art for constructing spatial optical filters on planar glass substrates or on curved or planar substrates made of metal, ceramic, plastic, semiconductor or crystal materials. In one example the spectral plane filter may comprise a hinged section of bulk or poly-silicon (mirror) that is lifted and held at an angle from the top surface of the substrate using any of a number of silicon micromachining techniques. Both the tilted mirror and the non-tilted substrate surface are coated with a gold or other reflective coatings so that incident light is efficiently reflected.

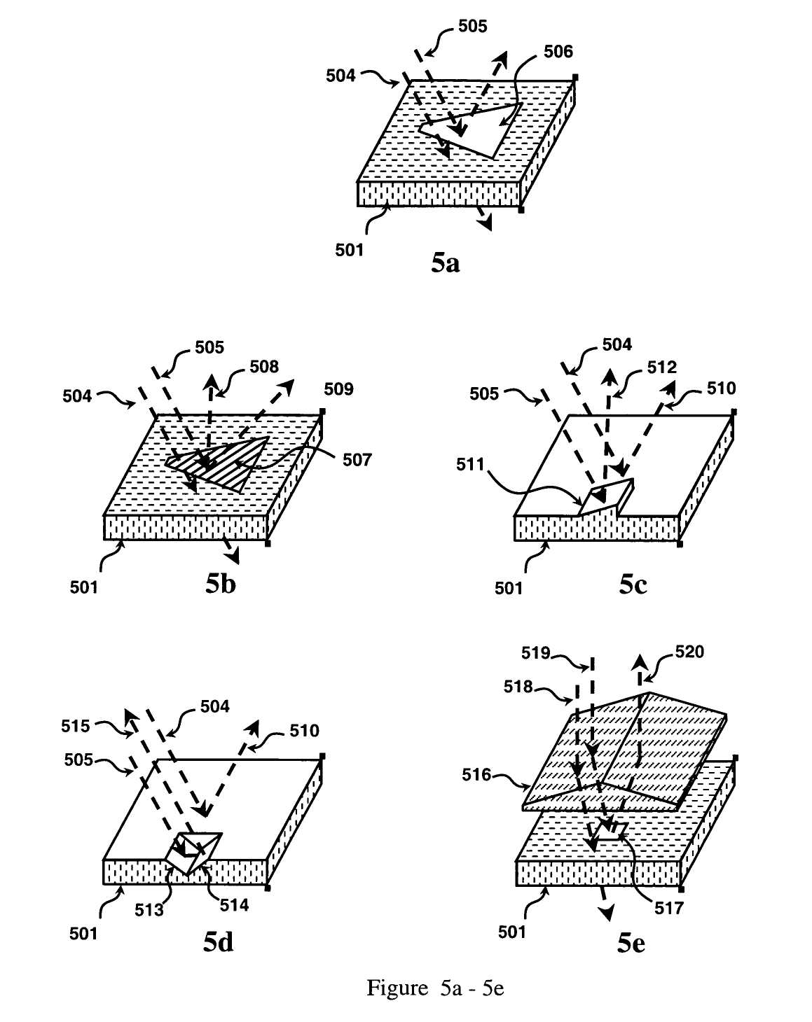

As an example of a spectral plane filter, FIG. 5a shows a reflection-based filter wherein the substrate 501 is patterned with a wedge shaped reflective feature 506, made for example with a metal or dielectric multi-layer film. With simultaneous reference now to FIG. 5a and FIG. 4, an optical beam 404 incident on the uncoated substrate will be transmitted through the substrate, while an adjacent optical beam 405 incident on the patterned feature will be reflected at a different angle.

FIG. 5b shows a diffractive-based filter where a substrate 501 is patterned with a wedge-shaped region of reflective diffraction grating, such that an optical beam 504 which is incident on the uncoated substrate will be transmitted through the substrate, while an adjacent optical beam 505 incident on the reflective diffraction grating will be diffracted and reflected into one or more directions. In the example shown in FIG. 5b, the incident signal 505 is split and diffracted into two output signals 508 and 509. Such a diffraction grating may be made, for examples, with holographically recorded sinusoidal metal-coated analog surface relief profile, or a lithographic digital computer-generated diffraction pattern. The same concept can also be implemented using a transmissive phase diffraction grating that would redirect the transmitted optical signals.

FIG. 5c shows a reflection-based filter where a substrate 501 is fabricated with a surface relief profile then uniformly coated with a reflective layer such that an optical beam 504 which is incident on the flat portion of the substrate will be reflected into an output 510 symmetric about the surface normal, while an adjacent optical beam 505 incident on the patterned tilted feature 511 will be reflected into an output 512 propagating in an different direction determined by the surface normal of the tilted region.

FIG. 5d shows a different reflection-based filter using a more complicated two-bounce concept where a substrate 501 is fabricated with a surface relief profile then uniformly coated with a reflective layer such that an optical beam 504 which is incident on the flat portion of the substrate will be reflected into an output 510 symmetric about the surface normal, while an adjacent optical beam 505 incident on the patterned tilted feature 513 will be reflected off the adjacent patterned surface feature 514 and then reflected into an output 515 propagating in an different direction determined by the orientations of the two surface features. In the example drawn in FIG. 5d, the surfaces are oriented at 45° to the substrate normal such that the output signal 515 propagates backwards to the incident signal 505.

Finally, FIG. 5e shows a two-element filter composed of a roof prism 516 supported above a substrate 501 having a patterned reflector 517 such that an incident optical beam 518 will refract from a first facet of the roof prism and then be transmitted through the substrate, while an adjacent optical beam 519 will refract from a first facet of the roof prism then be reflected and refracted from a second facet of the roof prism into output signal 520. In the example drawn in FIG. 5f, the roof prism angles and separation from the substrate have been designed so that the output signal 520 is laterally shifted but substantially counter-propagating relative to the incident signal 519.

The patterned features shown in FIGS. 5(a-e) can be created using known techniques in semiconductor device processing. For example, the filter of FIG. 5a can be fabricated using, for example, evaporative deposition of metal followed by lithographic patterning and selective removal of a wedge-shaped region of metal to reveal the underlying substrate. It should be further understood that the wedge-shaped feature used in several of the examples of FIGS. 5(a-e) was chosen for illustration purposes only, and that the same concepts can be applied to implement arbitrary surface profiles, including both digital (binary) and analog (gray-scale) features. An example of gray-scale features would be a partially reflective coating (as in FIG. 5a), or an angled reflective feature with continuously varying slope (in FIG. 5c). It should also be understood that combinations of the concepts shown individually in FIGS. 5(a-e) are also possible.

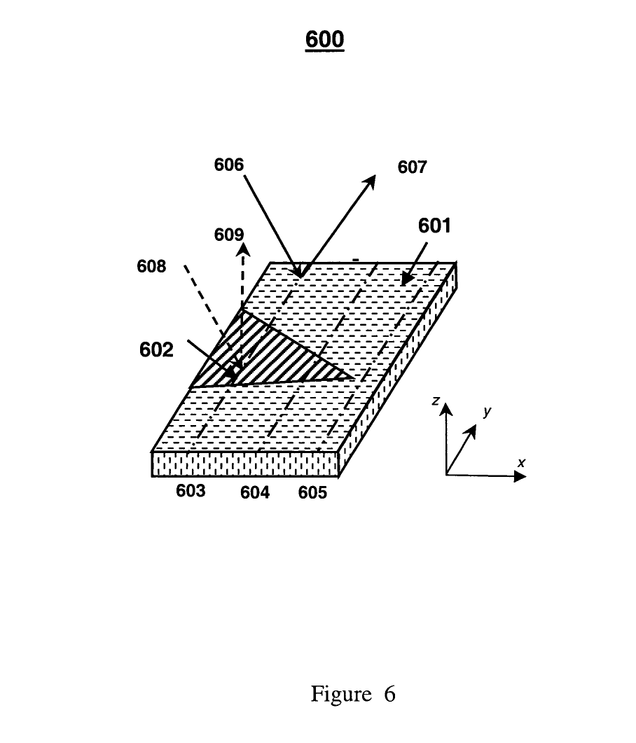

With reference to FIG. 6, a specific example of such a spectral plane filter 600 is described where the said filter has a specular region 601 surrounding a triangular diffraction grating 602. The triangular diffraction grating 602 directs an input signal channel 608 to a drop port 609 whereas the specular surrounding field 601, with no grating, directs an input signal channel 606 to an express port 607. Of course, the grating could be written on the specular field region instead of on the triangle. Likewise both regions could consist of gratings of different period and/or orientation so as to direct incident light into different angles depending on which region is illuminated.

In one embodiment of the invention, the operation of such a filtering device for drop and express channels selection can be explained with simultaneous reference to FIG. 1 and FIG. 6. The multi-wavelength input signal striking the grating 106 is dispersed into a column of intensity spots in the dispersed spectral plane. By controlling the position of the tip/tilt stage 107 by electrical controls 108, any portion of the dispersed spectrum can be imaged onto the triangular grating of the spectral plane filter shown in FIG. 6. The light from optical signal channels imaged onto the grating of the spectral plane filter is reflected and directed to the drop port. The bandwidth of the light passed to the drop port can be varied by moving the dispersed spectrum in the x-direction, for example from position 603 to 604 along the base of the triangular grating. The center wavelength is tuned by moving the spectrum in the y-direction.

If the spectrum is imaged along a position 605, then the center wavelength can be changed without changing the configuration of the spectral plane filter. That is, all the signals are continuously directed to a single output port. Similarly, it is also possible to direct any wavelength to the express port by simple translation operations. Those skilled in the art can see that with relatively simple translation operations a single spectral plane filter is continuously tunable in wavelength to drop any of the input signal channel(s) while directing the rest of the signal channels to other output ports. Since grating diffraction angle is wavelength dependent, it can lead to some wavelength dependent loss if uncompensated.

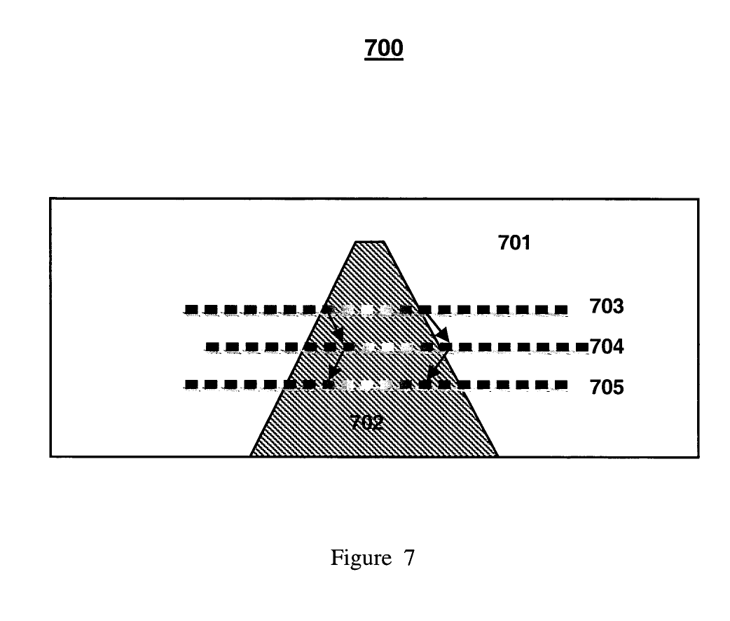

The operation of such a spectral plane filter to add a new wavelength channel(s) to one or a group of channels going to the drop port can be understood with reference to FIG. 7. As has been explained earlier with reference to FIG. 6 that the signal bandwidth directed to the drop port is changed by simply translating the beam up or down along the base of the triangular grating on the spectral plane filter.

Turning our attention to FIG. 7, it shows an example of an intensity profile of a dispersed multi-wavelength input signal striking the triangular grating 702 of the spectral plane filter 700. Each intensity spot corresponds to a different wavelength component of the multi-wavelength input signal that will be directed to the drop port after reflection from the grating whereas the wavelengths falling outside this triangular grating region 701 are directed to the express port. By steering the beam from position 703 to position 704 on the grating an additional channel from the left of the spectral profile could be added to the drop port. Similarly by steering the beam from a position 704 to a position 705, additional channels on the right could be added to the drop port. Those skilled in the art can see that moving the intensity profile on the triangular grating 702 along its sides will change the number of channels added to the drop port. The rest of the channels that fall outside the triangular grating will be directed to the express port.

In telecommunication systems, it is important that the optical signal channels that are not being switched during a switching operation transmit uninterrupted. As can be appreciated, the example presented here satisfies that criterion.

In general, any signal channel that remains on a continuous homogeneous region (i.e. across which the angle of deflection as a function of input angle is constant) as the spectrum is translated laterally will not be interrupted during the switching or reconfiguration operation. Thus, the switching operation is said to be hitless for that optical signal channel. In this example, switching is hitless for all the optical signal channels that are directed to the express port initially and finally. Likewise, switching is hitless to the optical signal channels directed to the drop port initially and finally. Only those optical signal channels that are changed from the express port to the drop port or vice versa (i.e. switched are interrupted).

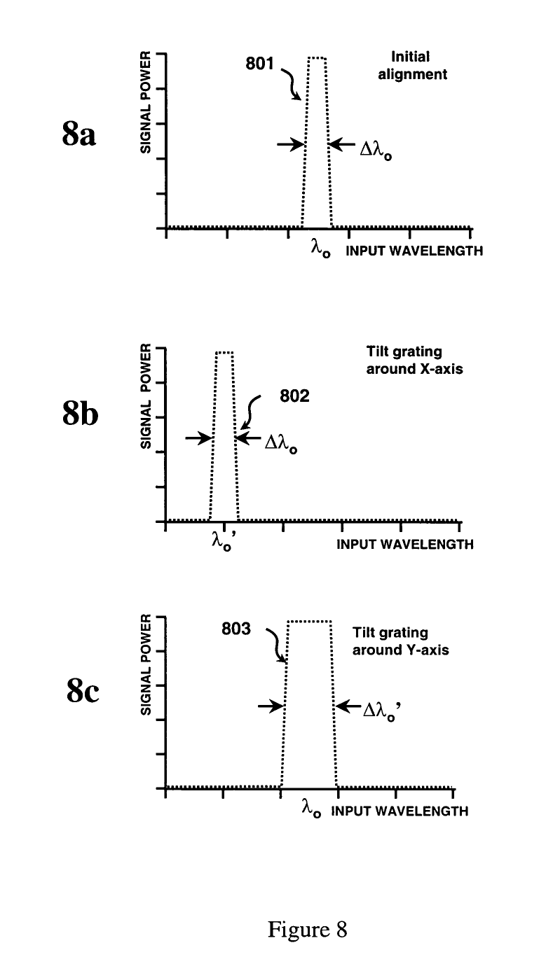

FIG. 8a to 8c shows graphs of the spectral response (the signal intensity as a function of signal wavelength) for tunable filtering device 100 during its operation. FIG. 8a shows the spectral response in the initial alignment of the system. The graph shows a characteristic spectral peak 801 with a spectral bandwidth (labeled Δλₒ) and center wavelength (labeled λₒ) near the center of the spectral response curve. When diffraction grating 106 is rotated around its X-axis, the spectral response peak 802 shown in FIG. 8b is shifted to a lower center wavelength λₒ′, but the shape and spectral bandwidth λₒ is unchanged.

However, if instead of rotating the filter around its X-axis, the filter is rotated around its Y-axis the spectral response peak 803 shown in FIG. 8c is unchanged in center wavelength λₒ and is instead changed in spectral bandwidth to a new value Δλₒ′ determined by the width of the illuminated portion of the triangular grating.

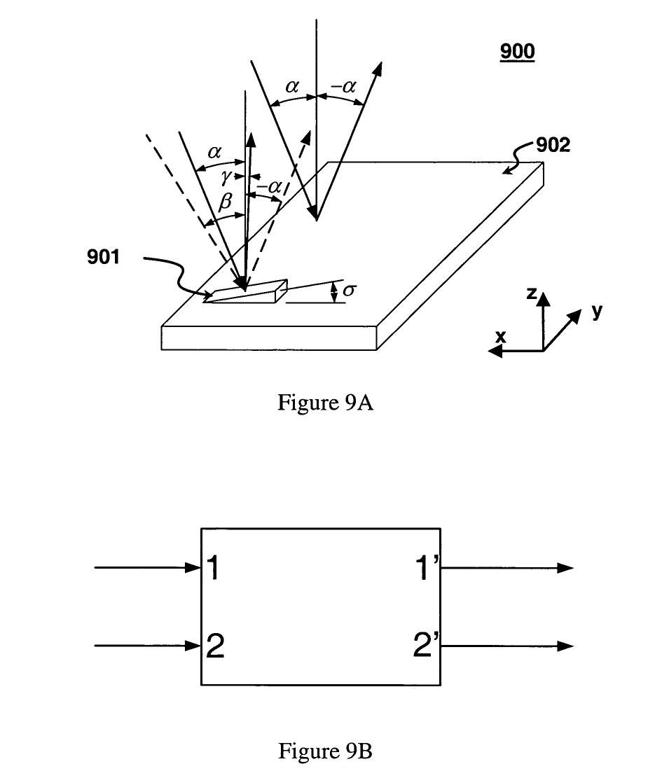

One embodiment of the invention shown in FIG. 9a, and with simultaneous reference now to FIGS. 9a and 9a, the device shown in 9a utilizes a spectral plane filter 900 with a reflective facet 901 surrounded by a reflective field 902. The facet is tilted with respect to the field at angle σ. The spectral plane filter 900 may be used in a reconfigurable optical add/drop switch that has two inputs and two outputs. Optical signals from one input, Input 1, are imaged onto the spectral plane filter at an angle α from the normal to the field. Optical signals from the other input, Input 2, are imaged onto the spectral plane filter at an angle β from the normal to the field. Wavelength signals reflected at angle −α are directed to Output 1′ while those reflected at angle γ are directed to Output 2′. The angles are chosen such that −α=σ−β, and γ=σ−α. Thus, wavelength signals incident on the facet 901 at angle α are reflected at angle γ and directed to Output 2′ while those incident on the field 902 at angle α are reflected at angle −α and directed to Output 1′. Likewise, those wavelength signals incident on the facet 901 at angle β are reflected at angle −α and are directed to Output 1′ while those that are incident on the field 902 at angle β are reflected at angle −β and, in this example, are not directed to any output.

The spectrum is dispersed along the y-axis. The band of wavelengths that strikes the facet may be called the ‘add/drop band’. With reference now to FIG. 9a, if we consider the express signal path to be from Input 1 to Output 1′, then it is clear that those wavelength signals within the add/drop band are removed or dropped from the express path and directed to Output 2′ while those outside the add/drop band continue on the express path. New signals within the add/drop band can be added to the express path at input2, from which they are reflected by the facet 901 to Output 1′.

The add/drop band can be tuned in wavelength by translating the imaged spectrum in the y-direction. By translating the spectrum in the x-direction, the add/drop switch may be turned off, so that the add/drop band disappears, or the bandwidth of the add/drop band may be tuned, if the facet has a triangular shape as shown in FIG. 6. Hitless reconfiguration is accomplished by first turning the switch off by moving all signals off the facet 901 along the x-axis, and then translating the spectrum in the y-direction. Finally the switch is turned on again at a new add/drop band with an x-translation.

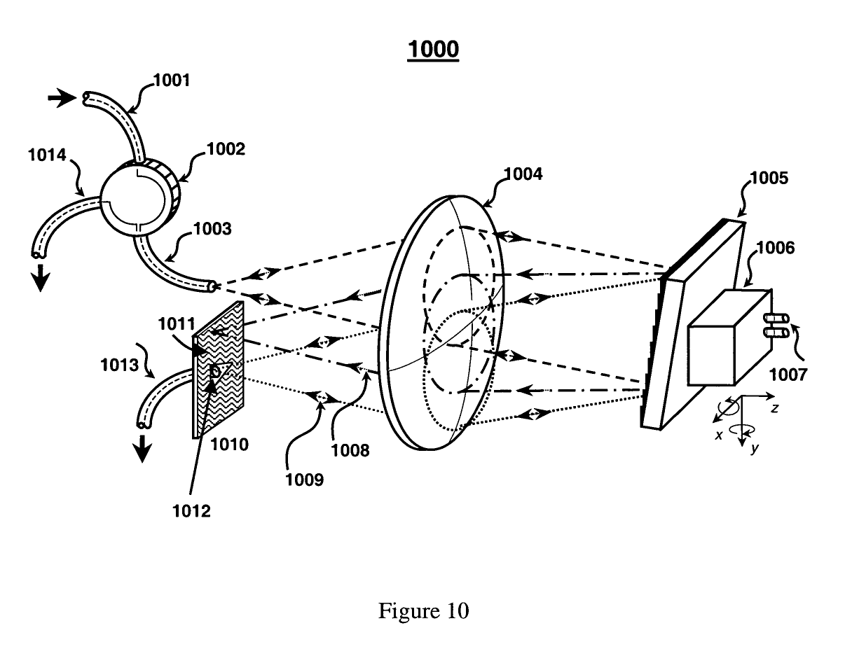

In one embodiment of the invention shown in FIG. 10, an add/drop system 1000 with double pass configuration is described. For simplicity of discussion the system 1000 is described with a single input port, a drop and an express port each.

With reference now to FIG. 10, multiple-wavelength input signal enters the system via the input fiber port 1001 of a circulator 1002. Input signal is launched into the free space through the circulator port 1003 and is focused by a lens 1004 on the grating 1005 mounted on a tip/tilt stage 1006. The stage can be controlled by electrical feedback signals through the electrical connectors 1007. The dispersed input signal in the form of an array of intensity spots (FIG. 7) strikes the spectral plane filter 1010 after a second pass through the lens 1004. The wavelengths that strike the region 1011 surrounding the aperture 1012 on the spectral plane filter are reflected back through the system and re-multiplexed by grating 1005, and are imaged on to the fiber 1003 facet. The circulator separates this output signal and directs it to the express output port fiber 1014.

Some portion of the spectrally dispersed input signal may pass through the aperture and some fraction of this light is collected by output fiber 1013. If the drop fiber is multimode fiber and the aperture is smaller than the core diameter, the spectral shape of the drop band is determined by the width of the aperture along the y-direction. If the aperture is triangular in shape, then the drop bandwidth varies by translating the spectrum in the x-direction on the spectral plane filter 1010. If the drop output fiber is a single mode fiber, then the drop band spectral shape is determined by the mode profile in the fiber (approximately Gaussian) in its central region and by aperture edges, in the wings of the band.

The device may perform hitless tuning by first translating the spectrum off the triangular aperture to a region where the entire signal is reflected and passed to the express output port 1014. Then the spectrum can be translated in the y-direction without signal interruption. Finally, the spectrum is translated in the y-direction so that a new band is dropped. Depending upon the design of the spectral plane filter, e.g. a spectral plane filter with multiple different physical features, the application of a spectral plane filter can be extended to incorporate multiple drop output ports. Those skilled in the art can appreciate that multiple bands of variable bandwidth signals can be dropped by a single spectral plane filter depending on the translation operations in x and/or y-directions. By extending the design of the system to incorporate multiple input ports (as shown in FIG. 9B), wavelength “add” function is implemented for a completely reconfigurable ROADM to any optical network.

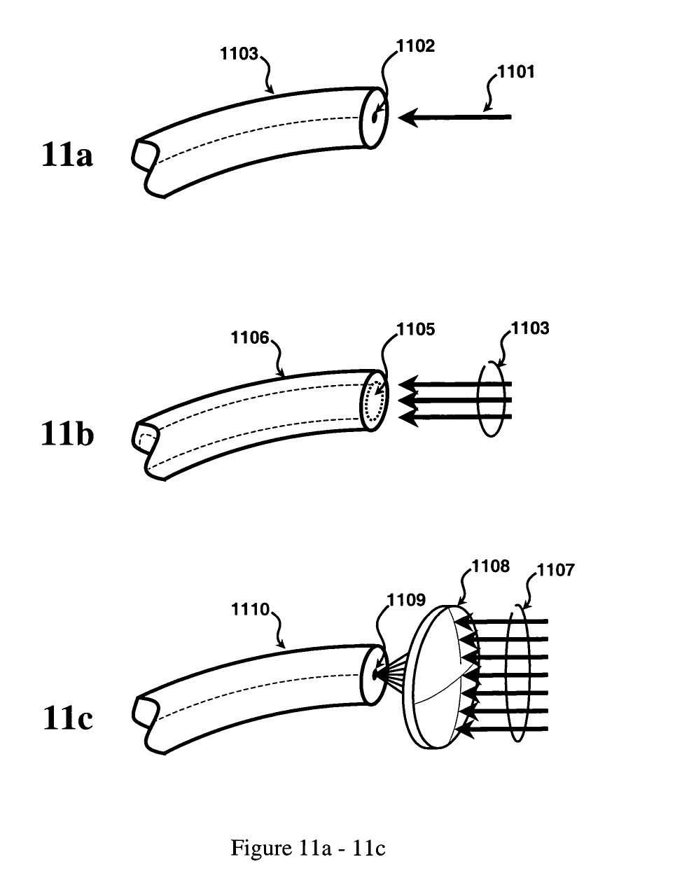

The drop output fiber 1013 may be a simple end-polished single mode fiber, as shown in FIG. 11a. However, signals at the dispersed spectral plane with significant wavelength bandwidth cover an area which is large compared to the mode field diameter of single mode fiber, and so will not couple with uniform efficiency into a simple end-polished single mode fiber. Several possible configurations for optical coupling are shown in FIGS. 11(a-c). FIG. 11a shows a single wavelength signal 1101 incident on the central core 1102 of a single mode optical output fiber 1103. Signals laterally misaligned substantially from the core by more than 10 microns will not couple into the output fiber.

FIG. 11b shows a group of wavelength signals 1104 incident upon the multi-mode core 1105 of a multi-mode output fiber 1106. Multimode optical fibers known in the art may have step index or graded index profiles, and can have core diameters that range from approximately 30 to 140 microns. In general, the larger the multi-mode fiber core, the broader the spectrum of signals that will couple directly into the multi-mode fiber.

However, modal dispersion in large core diameter multi-mode optical fibers restricts the distance that a high-speed data signal can be carried without impairment. FIG. 11c shows a third alternative configuration where a group of wavelength signals 1107 is coupled by a condenser micro-lens 1108 to focus on the core 1109 of a single mode (or small core diameter multi-mode) output fiber 1110. This configuration does not in general achieve perfect mode matching of any wavelength signal, and so cannot achieve loss less coupling. It is possible however to adjust the lens focal length and position to achieve uniform excess insertion loss over a moderately broad acceptance spectrum.

The spectral plane filter described in FIGS. 4, 6 and 9, reflect the Incident input signal channels at different angles depending upon the physical features on the spectral plane filter. As a result, the output signal channels after reflection from the spectral plane filter go in different directions. Additional optical elements such as prisms, mirrors and chirped or non-chirped diffraction gratings can be used in conjunction with the spectral plane filter to redirect all the output signal channels parallel to the optical axis through the rest of the optical system.

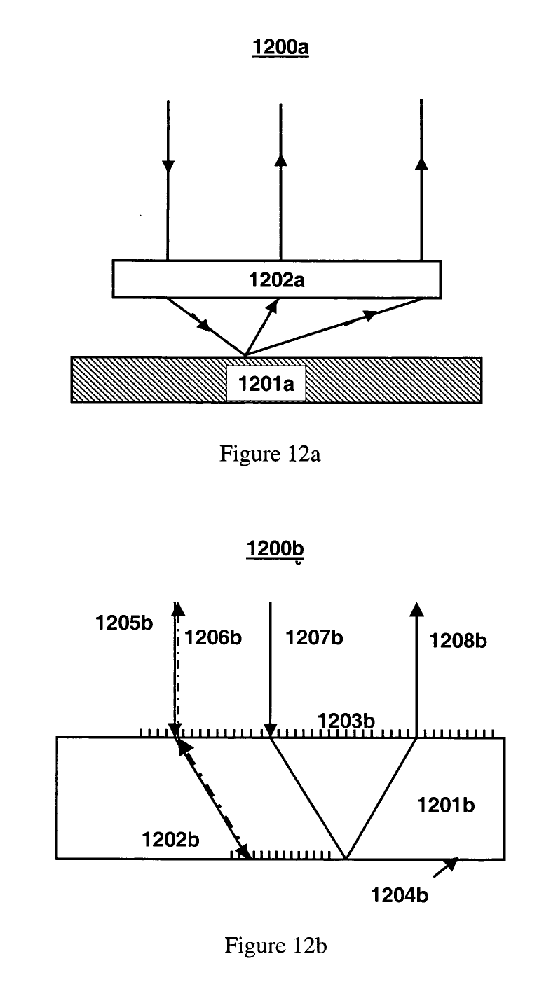

As shown in FIG. 12a, an additional angle/displacement converting optical element 1202a is placed between the spectral plane filter 1201a and the collimating lens such that all the output signal channels are made parallel with a fixed lateral separation after being deflected from the spectral plane filter. The angle/displacement conversion element 1202a for example may be a prism. Alternatively, a prism may be replaced by a non-chirped or chirped grating structure as shown in FIG. 12b.

With reference to FIG. 12b, in this example the spectral plane filter and the angle/displacement optics have been combined into a single structure 1200b. The reflective grating 1202b at the dispersed image plane 1204b on a glass substrate 1201b forms the spectral plane filter whereas the transmission grating 1203b on the opposite end forms the angle/displacement converting optics. An input signal channel 1205b striking the grating 1202b on the spectral plane filter returns to the same port as a drop signal 1206b whereas another input signal channel 1207b striking the spectral plane filter away from the grating 1202b returns as an express channel 1208b. The signal channels leaving the spectral plane filter become parallel. The gratings in this example can be fabricated by lithographically defined etching of the substrate or by any other grating fabrication techniques.

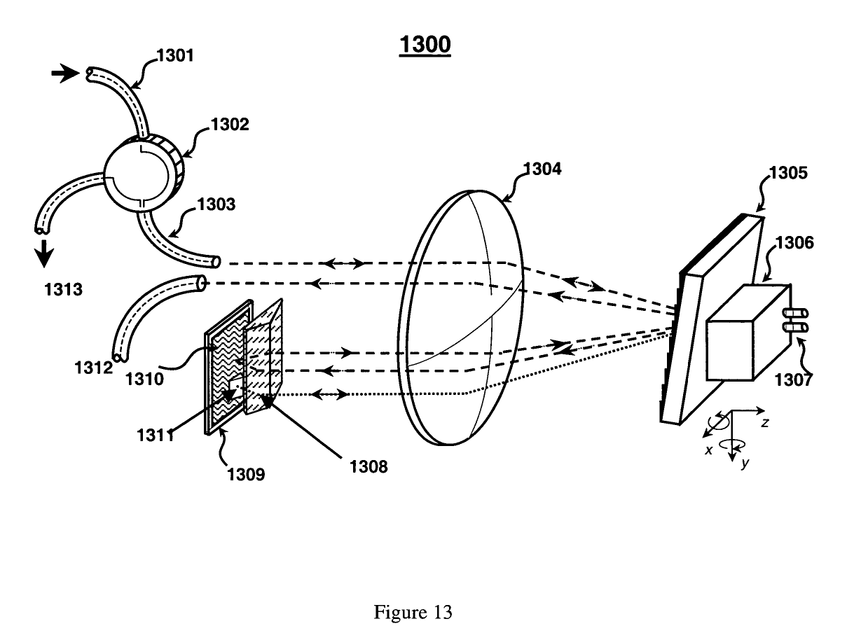

FIG. 13 illustrates how a prism may be used in the system to redirect the reflected beams to the appropriate output fibers. With reference to a single input system 1300 shown in FIG. 13, a multiple-wavelength input optical signal is incident on an input fiber port 1301 of a circulator 1302. The signal is launched into the free-space optics of the system through the fiber port 1303, and is focused by the collimator lens 1304 on the dispersion grating 1305 mounted on a tip/tilt stage 1306. The stage can be tilted around the x or the y-axis using a control signal transmitted through the electrical connectors 1307.

The dispersed beam makes a second pass through the lens 1304 and is directed onto the spectral plane filter 1309 through a prism 1308 placed directly in the path of the dispersed spectrum. Optical signal channels incident on the angle reflector 1311 are reflected back along the incident path. The return beam from the spectral plane filter via the prism is directed to the drop port 1313 via the focusing lens 1304 and the circulator port 1303. Optical signal channels incident on the flat field of the spectral plane filter are reflected at a complementary angle and pass back through the other half of the prism, resulting in the returning beam being displaced from the incident beam. The signal channels in this beam are re-multiplexed by the grating 1305 and passed onto the output port 1312. In this application, prism 1308 may be replaced by a non-chirped or chirped grating structure as shown in FIG. 12b.

Depending on the design of the physical features on the spectral plane filter, multiple numbers of output signals could be directed to different output fibers using a common optical arrangement. In the discussion here a single drop and express port each is shown for convenience. Tuning the center wavelength and the spectral shape of the signal going to the drop port is controlled by the translation/rotation operations of grating 1305 via the tip/tilt stage 1306. As can be appreciated, re-calibration of the feedback control is required. Thus those skilled in the art can appreciate that this device can be utilized in various different configurations to implement optical add/drop functionality in an optical network in a variety of ways.

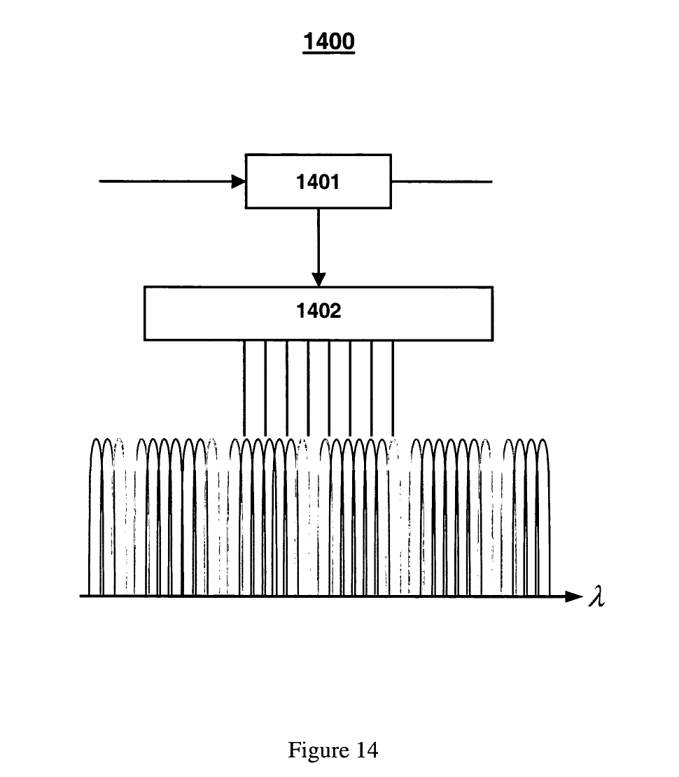

Periodic Arrayed Wave Guide (PAWG) can be used to de-multiplex a band of wavelengths emitted from the drop port of the variable bandwidth tunable optical filtering device described herein. Unlike regular AWG device, PAWG is a passive colorless devices that can de-multiplex or multiplex any 8, 16, 40 or some other fixed number of contiguous wavelengths in a multi-wavelength optical signal. Any demultiplexers with this periodic property may be used, a PAWG is selected for illustration. A schematic of such an arrangement 1400 is shown in FIG. 14 where a variable bandwidth tunable OADM device 1401 as taught herein is used as a band-pass filter to separate any contiguous 8 or fewer channels from a multi-wavelength optical signal. In this implementation the variable bandwidth tunable filtering device 1401 separates a set of wavelengths at each node just like a fixed bandwidth band-pass filter. However, unlike a fixed band-pass filter, this device in this method has the flexibility of selecting any band of wavelengths out of all the input signal wavelengths without having to physically replace the filtering device.

Moreover, the OADM can be reconfigured to drop a different band of optical signal channels without interrupting the signal channels that are not reconfigured. The band of wavelengths so separated by the filtering device 1401 is further de-multiplexed by the PAWG 1402 for processing individual signal channels as required. The same combination of identical components 1401 and 1402 can be used at each network with the filtering devices at different nodes being tuned to different sets of wavelengths at the respective nodes in accordance with the network design rules. Since the tunable filtering device is not specific for a given channel spacing, this combination allows seamless upgrade of channel spacing with the limitation on channel spacing imposed by the choice of PWAG and not by the variable bandwidth tunable filtering device. Therefore those skilled in the art can appreciate the versatility and potential of this filtering device and the method of OADM implementation in reducing the network complexity and cost.

All of the systems described so far use angular tilt of the collimated signal beams to introduce a lateral shift at the spectrally dispersed image plane. The same concepts for optical filtering using a permanent spectral plane filter can be also implemented using a physical translation of either the input fiber or the permanent spectral plane filter. A variety of physical translation actuators can be used to control lateral position, including for example threaded screws driven by stepper motors, by direct current motors, by piezo-electric actuators, or driven manually.

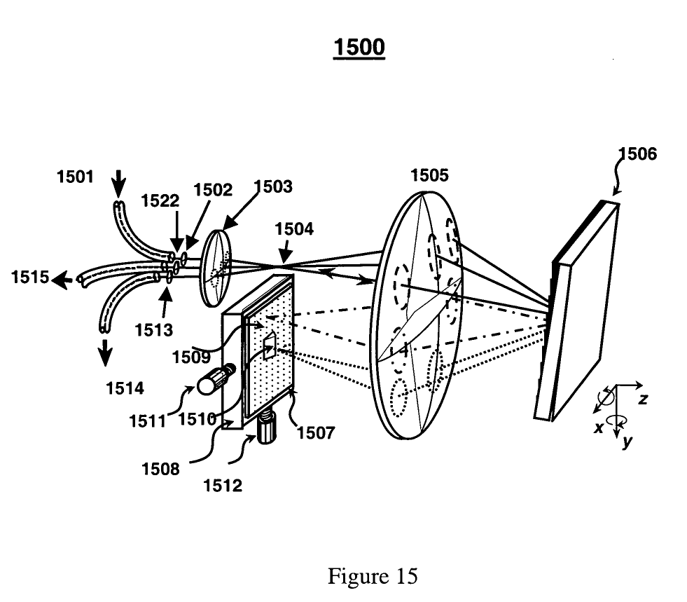

By way of an example, and with reference now to FIG. 15, there is shown an optical filtering device that is functionally similar to the optical filtering device 1000. An input signal carried on fiber 1501 is collimated by a micro-lens 1502 followed by a second micro-lens 1503 that focuses the input beam to spot 1504 at an angle to the optical axis in the lens. Lens 1505 re-collimates the beam and illuminates reflective diffraction grating 1506 that is now fixed in position. Each component of the input signal is diffracted at an angle corresponding to its wavelength, is focused by a second pass through lens 1505, and is imaged as a column of spots onto a permanent spectral plane filter 1507. The spectral plane filter in this case may be a triangular grating 1509 in a specular background 1508 as described in FIG. 6, or other type of filter described in FIG. 5 that reflects a selected portion of the signal back through the optical system, into either of the output fiber ports 1514 or 1515 through the lenses 1513 or 1522.

In this arrangement instead of using a tip/tilt stage for position control, the spectral plane filter 1507 is mounted on two-axis translation stage 1508 so that its lateral position can be directly controlled by horizontal (X-axis) and vertical (Y-axis) actuators 1511 and 1512, respectively. In FIG. 15, the two lateral position actuators are for example manual screws. Actuator 1511 then controls the center wavelength of the transmitted signal, and actuator 1512 controls the wavelength bandwidth of the transmitted signal. Equivalent lateral-shifting embodiments can be constructed for each of the systems described herein.

Closed loop control of the angular position of tip/tilt mount e.g. 107 in system 100 (FIG. 1) based on feedback from some measurement of position can enable greater accuracy and stability. Closed loop control can be based on an external measurement of the optical signal coupled into the output fiber as, for example, an optical spectrum analyzer elsewhere in the fiber optic communications system. It is preferable, however, to provide an internal measurement of the signal position.

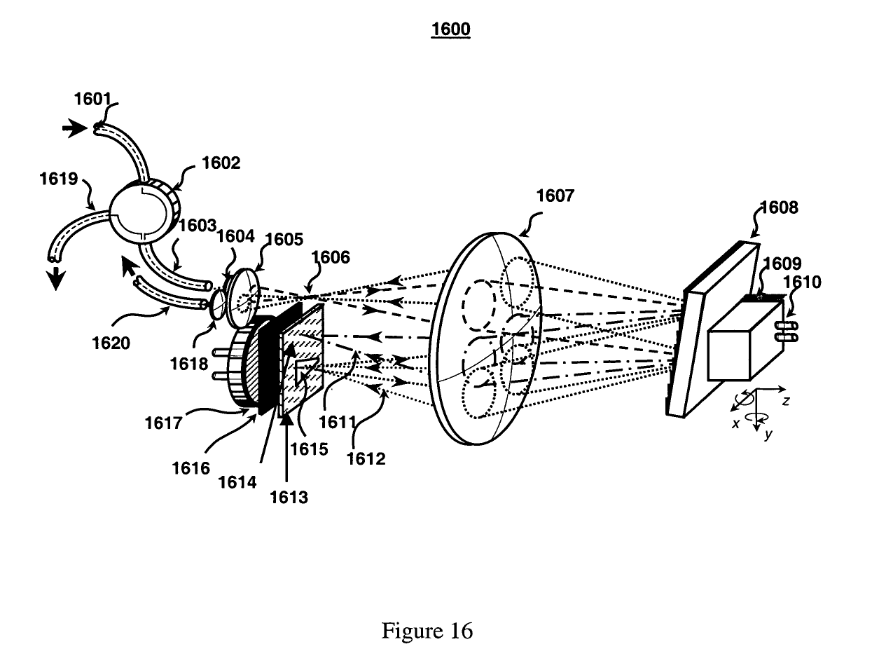

A system 1600 with such a closed loop feedback position control is shown in FIG. 16. Although functionally similar to the filtering device 1500 described earlier, this system includes a means for optically monitoring the position of the dispersed spectrum at the spectral plane filter. With simultaneous reference now to FIG. 16, input signal at the fiber port 1601 passes through an optical circulator 1602 to the input port 1603 of the filtering device. Unlike in system 1500, the dispersion grating 1608 is mounted on a tip/tilt stage 1609 with feedback control provided through the electrical connector 1610.

The spectral plane filter 1613 in this case includes a number of elements. The first element is a reflective region 1615 that reflects light back through the system to output port 1620 through lens 1618. The reflective field 1614 reflects light back into the circulator port 1603. The circulator directs this return signal to drop output port 1619. The reflective field contains a spatial filter 1616, an array of transparent or semi-transparent slits that allow light to pass through the spectral plane filter to a large aperture optical detector 1617 positioned behind spatial filter 1616 such that any light that is transmitted through spatial filter 1616 is detected. The combination of spatial filter 1616 and detector 1617 registers an electrical signal in response to the spatial position of optical signals and so is useable for feedback control of tip/tilt stage 1609 or to detect changes in the center wavelengths of one or more of the optical signals passing through the optical filtering device.

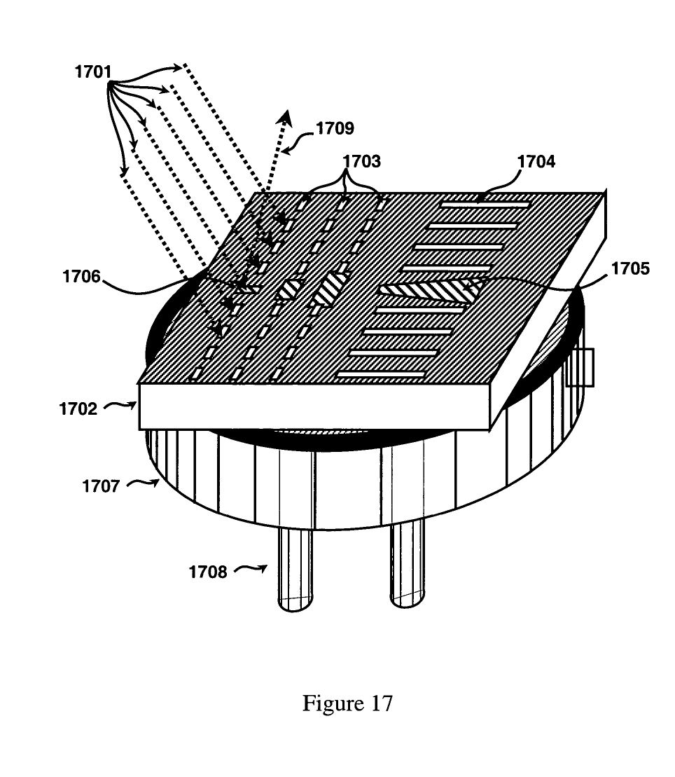

The use of patterned apertures for feedback control is understood with simultaneous reference to FIG. 16 and FIG. 17, which shows a closer view of the combination of the patterned spectral plane structure 1613, patterned aperture 1616 and detector 1617 from optical filtering device 1600 of FIG. 16. Referring to FIG. 17 now, a column of input signals 1701 corresponding to 6 wavelengths on the transmission grid (for example at 100 GHz pitch) illuminate a transparent substrate 1702 coated with a reflective layer except where patterned with sets of apertures 1703 and 1704, and reflective regions 1705 and 1706 that reflect light at a different angle than the reflective field.

In general, multi-wavelength telecommunications systems use signal wavelengths that lie on the telecommunications standard ITU grid, which specifies allowed center wavelengths on a 50 GHz (0.4 nm) pitch. In specific applications, the signal wavelength may be known to lie on a restricted subset of these wavelengths, as for example in a C-band system with 40 signals at a 100 GHz pitch. Each wavelength signal can be expected to lie slightly above or below the target value, but the average of multiple signals is relatively accurate indication of the average signal wavelength. In any case, the relative position of any single wavelength signal is important in determining (and maintaining) optimum performance of the multi-wavelength transmission system. Therefore a prior knowledge about the signals entering optical filtering device 1600 can be used to measure the wavelength of each single wavelength signal relative to the median position of the signals entering filtering device 1600.

The column of intensity spots 1701 from the dispersed multi-wavelength input optical signal entering the filtering device are spectrally dispersed onto the aperture array 1703. The lateral separation of the apertures is chosen to match the signal wavelength pitch such that the signal registered upon the detector 1617 (FIG. 16) is a minimum for discrete alignments of tip/tilt stage 1609 (FIG. 16) for which the actual wavelengths of the WDM channels present align, on average, with locations in the filter spectral response corresponding to the design wavelengths. In effect, the detector registers the convolution of the signal wavelengths with a comb filter designating the design values. Once the signals are roughly aligned, the analog electrical output signal from detector carried on electrical connections 1708 can then be used for accurate position feedback.

Shown in FIG. 17, are patterned mirrors 1705 and 1706 to reflect the signal of interest 1709 into the optical outputs. In this example the signal falling on detector 1707 is maximized when one of the wavelength channels 1701 is centered on the reflective surface 1706. With appropriate design of the aperture pattern, a variety of position feedback systems can be implemented to accommodate specific filter functions and system environments.

Although all of the system embodiments described so far use reflective optical system geometries based on the reflective beam steering configurations shown in FIGS. 4(a-d), it is also possible to construct an optically equivalent system using a transmissive beam steering means. Such means can include, for example, use of rotating prism pairs (e.g., William L. Wolfe, Introduction to Infrared System Design, SPIE PRESS Volume TT24, Chapter 12), liquid crystal beam deflectors (e.g., R. McRuer et al, “Ferroelectric liquid-crystal digital scanner”, Opt Lett. 15, pp. 1415-1417, 1990; see also U.S. Pat. No. 4,964,701) and electro-optic beam deflectors (e.g., J. Thomas and Y. Fainman, “Optimal cascade operation of optical phased-array beam deflectors,” Applied Optics, Vol. 37(26), pp. 6196-212, 1998).

In systems that use a second pass of the optics to recollect the filtered multi-wavelength signals into a single mode output fiber (e.g., FIG. 1, 100; FIG. 10, 1000; FIG. 13, 1300; and FIG. 16, 1600) the ideal position of both the tilting mechanism and the diffraction grating is in the back focal plane of the large collimation lens (FIG. 1, 105). This provides telecentric imaging, and optical coupling efficiency of the recollected signals into the single mode output fiber. This can be achieved using a bulk reflective grating directly mounted on a macroscopic optomechanical tip/tilt stage 107, as drawn in FIG. 1. It can also be achieved in a more cost-effective way by combining the reflective grating with a micromechanical tip/tilt device. Single-tuning axis micromechanical angle-tuned diffraction gratings suitable for laser tuning have been demonstrated in prior art, e.g. M. H. Kiang, et al, “Surface-Micromachined Diffraction Gratings for Scanning Spectroscopic Applications,” Proc. Int. Conf. Solid-State Sensors and Actuators, Chicago, Ill., June 1997.

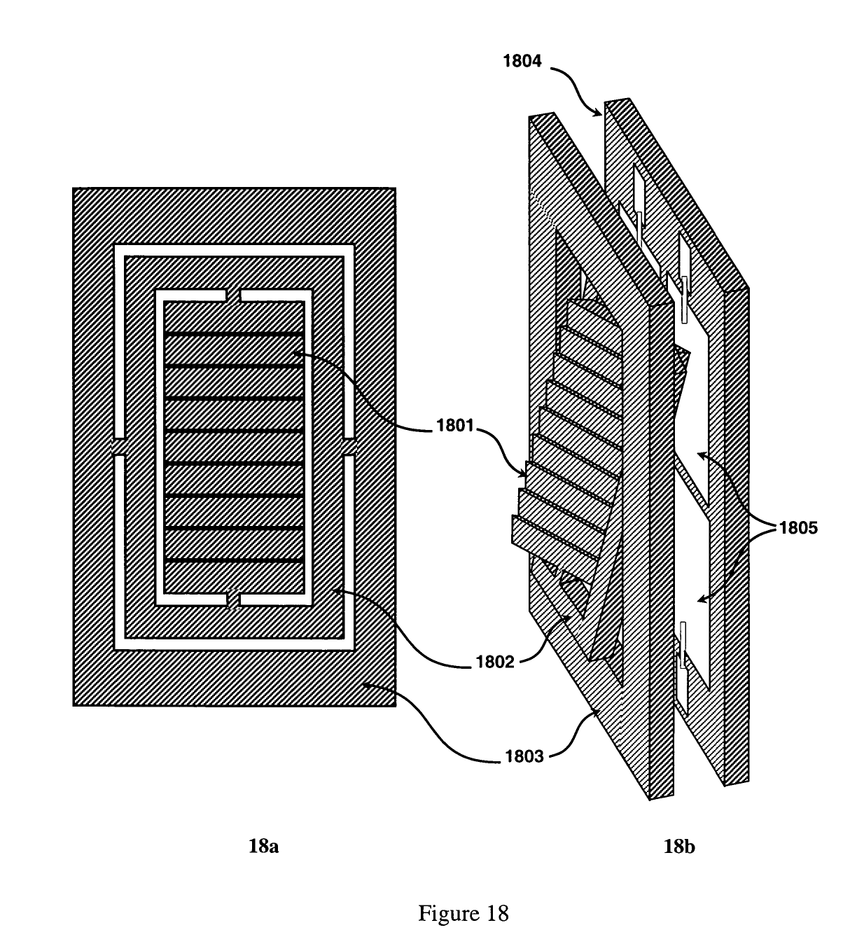

Finally, a two-axis angle-tuned diffraction grating suitable for spectrum steering is shown in FIG. 18. For ease of discussion a front and a side view is shown in FIG. 18a and FIG. 18b, respectively. With reference now to FIG. 18, a planar silicon upper substrate is micromachined into a planar diffraction grating 1801 connected by two torsion bars to an inner gimbal ring 1802, which is in turn connected by two torsion bars to an outer gimbal ring 1803. The upper substrate is supported with an air gap above a lower substrate 1804 (FIG. 18b) and is patterned with electrodes 1805 (FIG. 18b) capable of creating an electrostatic attractive force on a portion of the movable grating such that the angular position of the grating can be controlled by applying a combination of voltages to the control electrodes. Such a device can be fabricated using, for example, a silicon-on-insulator bulk silicon MEMS fabrication process where the diffraction grating is formed using binary or analog surface profile etching of a upper silicon layer, silicon oxide as a dielectric stand-off layer, and wafer bonding to join the top layers to a lower substrate which is patterned with the drive electrodes. Silicon is transparent to the telecommunications wavelength region, so it is possible to pattern the diffraction grating surface relief on either the top or bottom of the upper silicon layer, provided a reflective coating (typically one or more thin layers of metal) is applied to the grating surface relief pattern.

Functionally identical angle-tunable diffraction gratings can be constructed by fabricating a diffraction grating on any micromechanical structures developed to position a two-axis tilt mirror, including surface micromachining with electrostatic plate actuators, bulk micromachining with comb drive actuators. The grating would ideally be fabricated as a surface relief profile etched into the top planar structure. It is also possible to emboss a grating on the surface of an otherwise planar structure, as for example using a thin layer of epoxy which is shaped by physical contact with a master grating structure (a technique used in the art of replicating fixed surface relief diffraction gratings), or using a thin layer of optical sensitive material, such as photopolymer, and optically recording a holographic grating structure (a technique used in the creating of fixed holographic gratings).

Various additional modifications of this invention will occur to those skilled in the art. Accordingly, all deviations from the specific teachings of this specification that basically rely upon the principles and their equivalents through which the art has been advanced are properly considered within the scope of the invention as described and claimed.

1. An optical apparatus comprising:
at least three ports wherein said ports include at least one input port and at least one output port;
a spectral demultiplexer to spatially separate one or more multi-wavelength input signals received at an input port as a function of wavelength;
a single invariant optical spatial filter positioned at the demultiplexed image plane to selectively direct each laterally shifted, spatially separated wavelength input signal to an output port as a function of wavelength,
a means for laterally shifting the spatially separated multi-wavelength input signals relative to the invariant optical spatial filter at the demultiplexed image plane;
a spectral multiplexer to spatially combine the dispersed multiwavelength output signals and direct said signals into a desired output port.

2. The optical apparatus according to claim 1 wherein all of the input port(s) may be operated as output port(s) and all of the output port(s) may be operated as input port(s).

3. The optical apparatus according to claim 1 having at least two input ports and at least two output ports.

4. The optical apparatus according to claim 1 wherein a one-to-one correspondence exists between each input port and the incident angle of signals from that port at the spatial filter, relative to its surface normal, and between each output port and the angle of signals deflected to that port from the spatial filter, relative to its surface normal.

5. The optical apparatus according to claim 4 in which beams of light traversing from one or more input ports to the fixed optical spatial filter and from the fixed optical spatial filter to one or more output ports intersect a optical pupil in non-overlapping spots.

6. The optical apparatus according to claim 1 wherein the apparatus is an anamorphic optical imaging system.

7. The optical apparatus according to claim 1 wherein the means for laterally shifting the spatially separated multi-wavelength input signals relative to the invariant optical spatial filter at the demultiplexed image plane is a beam steerer directing the optical signals.

8. The optical apparatus according to claim 1 wherein the means for laterally shifting the spatially separated multi-wavelength input signals relative to the invariant optical spatial filter at the demultiplexed image plane is a lateral translator positioning the invariant optical spatial filter.

9. The optical apparatus according to claim 7 wherein the beam steerer includes a tiltable reflective diffraction grating.

10. The optical apparatus according to claim 7 wherein the beam steerer includes a tiltable mirror.

11. The optical apparatus according to claim 7 wherein the beam steerer includes a lens for converting angular shift into lateral shift.

12. The optical apparatus according to claim 11 wherein the multiplexer includes the beam steerer lens.

13. The optical apparatus according to claim 1 wherein the spectral de-multiplexer and the spectral multiplexer includes a diffraction grating.

14. The optical apparatus according to claim 1 wherein the beam steerer includes:
a position sensor for detecting the position of the beam steerer.

15. The optical apparatus according to claim 4 wherein the spatial filter includes a reflective field surrounding other reflective surfaces whose surface normals are tilted relative to the surface normal of the reflective field.

16. The optical apparatus according to claim 15 further comprising:
a reconfigurator that varies the spatial position of the spectrally dispersed input signals relative to the spatial filter;
such that switched signals transition from a surface at one angle to a surface at a different angle while non-switched signals remain on a continuous surface of substantially fixed angle and thus are not interrupted during the reconfiguration.

17. The optical apparatus according to claim 4 wherein the fixed spatial filter includes one or more diffraction gratings of different spatial frequency positioned within a diffractive field grating of a different spatial frequency.

18. The optical apparatus according to claim 1 further comprising:
a reconfigurator that varies the spatial position of the spectrally dispersed input signals relative to the spatial filter;
such that switched signals transition from a grating at one spatial frequency to a grating at a different spatial frequency while non-switched signals remain on a continuous grating of substantially fixed spatial frequency and thus are not interrupted during the reconfiguration.

19. The optical apparatus according to claim 9, wherein the grating is a selectively tiltable MEMS grating.

20. The optical apparatus according to claim 10, wherein the mirror is a selectively tiltable, opto-mechanical MEMS tilt mirror

21. The optical apparatus according to claim 1 further comprising a means for determining the position of the spectrum on the spatial filter.

22. The optical apparatus according to claim 21, wherein the position determining means includes a detector that determines the position of a signal on the spatial filter.

23. The optical apparatus according to claim 1, wherein the spatial filter includes a director that directs a portion of the light striking the filter.

24. The optical apparatus according to claim 23 wherein said director includes an aperture.

25. The optical apparatus according to claim 24 wherein said director includes a tilted mirror or grating.

26. In an optical switch having a plurality of ports, a method of switching a received multi-wavelength signal from one of said ports to another of said ports, the method comprising the steps of:
spatially separating the multi-wavelength signal as a function of wavelength;
laterally shifting the spatially separated multi-wavelength signal at the demultiplexed image plane relative to an invariant spatial filter;
selectively directing, each shifted spatially separated wavelength input signal to a desired port as a function of wavelength; and
spatially combining the dispersed multiwavelength output signals
such that desired multiwavelength signals are switched from one of the ports to another of said ports.

27. The method according to claim 26 further comprising the steps of:
switching all of the signals to a first output port;
reconfiguring the position of the signals relative to an invariant spatial filter while directing all of the signals into the first output port; and
switching a selectable portion of the signals into a second output port while directing the remainder of the signals into the first output port.

28. The method according to claim 26 further comprising the steps of:
changing the number of signals (equivalently, the spectral bandwidth of the signal) directed into one or more output ports while not interrupting those signals initially directed into said output ports that are not being switched from one output port to another.
